(19) United States
(12) Patent Application Publication
(10) Pub. No.: US 2008/0005639 A1
(43) Pub. Date: Jan. 3, 2008

(54) Apparatus, method and computer program product providing uplink H-ARQ using limited signaling

(75) Inventor: Frank Frederiksen, Klarup (DK)

Correspondence Address: HARRINGTON & SMITH, PC, 4 RESEARCH DRIVE, SHELTON, CT, 06484-6212, US

(73) Assignee: Nokia Corporation

(21) Appl. No.: 11/473,276

(22) Filed: Jun. 20, 2006

(51) Int. Cl. H04L 1/18

(52) U.S. Cl. 714/751

(57) ABSTRACT

Disclosed is a method, a computer program product and a device operable to receive a packet at a first network device from a second network device; to decode the received packet using a first decoding scheme defined for decoding a new transmission of a packet, and to also decode the received packet using a second decoding scheme defined for decoding a re-transmission of a packet and, in response to decoding, to determine whether the received packet is a new transmission of a packet or a re-transmission of a previous packet, without requiring an explicit signaling from the second network device for specifying the type of the packet.

### TECHNICAL FIELD

The teachings in accordance with the exemplary embodiments of this invention relate generally to data transmission procedures and protocols and, more specifically, relate to techniques that transmit data from a transmitter to a receiver, and that re-transmit the data upon an occurrence of a reception error detected at the receiver.

### BACKGROUND

The following abbreviations are herewith defined:

| | |
|---|---|
| 3GPP | Third Generation Partnership Project |
| ACK | Acknowledgment |
| CDMA | Code Division Multiple Access |
| CRC | Cyclic redundancy check |
| DL | Downlink (Node-B to UE) |
| H-ARQ | Hybrid automatic repeat request |
| HSUPA | High Speed Uplink Packet Access |
| LTE | Long Term Evolution |
| MAC | Medium Access Control |
| NACK | Negative acknowledgment |
| Node B | Base station |
| PUSCH | Physical Uplink Shared Channel |
| RNC | Radio Network Controller |
| RLC | Radio Link Control |
| RRC | Radio Resource Control |
| SAW | Stop and Wait |
| SFN | System Frame Number |
| UE | User Equipment, a mobile terminal |
| UL | Uplink (UE to Node-B) |
| UTRAN | Universal Terrestrial Radio Access Network |

A proposed communication system known as evolved UTRAN (E-UTRAN, also referred to as UTRAN-LTE) is at present a work item within the 3GPP. In order to allow for near-optimum performance the current working assumption is that H-ARQ will be applied for both link directions (i.e., for the UL and the DL). The use of H-ARQ will enable the system/users to operate at relatively high packet error rates, since the H-ARQ re-transmissions are expected to typically be capable of recovering a data packet when combining soft decoder values received for an earlier transmission(s) of the packet.

For the DL, it is not yet resolved whether the H-ARQ operation should be synchronous or asynchronous in nature. For the UL, however, the current working assumption is that the H-ARQ operation will be synchronous. The synchronous operation implies that a H-ARQ re-transmission takes place at a predetermined offset relative to the original transmission. In this manner some signaling resources may be reduced or totally omitted, as the Node B knows when to expect the re-transmission of the packet that was in error. The use of synchronous H-ARQ operation is previously known from the 3GPP HSUPA concept (proposed as an improvement to wideband CDMA (W-CDMA)).

For the 3GPP LTE uplink, the H-ARQ functionality in the synchronous mode should operate such that the H-ARQ SAW channel number is defined and derived from the SFN.

For the UL data channel to incorporate H-ARQ, three entities are needed in terms of physical channels:

the PUSCH (for carrying the user information data);
the uplink H-ARQ information channel; and
the corresponding downlink signaling channel for ACK/NACK.

The data transmitted on the PUSCH should be encoded according to the selected forward error correction scheme, and error detection in terms of the CRC should also be applied. The forward error correction scheme should preferably support some type of rate matching control, as is done for HSUPA. In HSUPA, it is possible to predefine for use a sequence containing the rate matching strategy for a given re-transmission number. For the 3GPP LTE uplink, such a re-transmission strategy should be signaled to the UE through RRC configuration messages.

As for the associated ACK/NACK, this indication should be transmitted either along with the normal allocation information, or as part of a special ACK/NACK field (placed inside or outside of the allocation information which is transmitted in the downlink).

However, a problem that is presented given the foregoing scenario is that while the Node B knows the SFN, and has knowledge of the re-transmission strategy, it still requires an indication of the presence of new data (a first transmission of a packet) that is sent from the UE. This new data indication consumes some amount of available bandwidth (at least one signaling bit). Prior to this invention, this problem was not addressed or solved.

### SUMMARY OF THE EXEMPLARY EMBODIMENTS

The foregoing and other problems are overcome, and other advantages are realized, in accordance with the non-limiting and exemplary embodiments of this invention.

In accordance with a first non-limiting embodiment of this invention there is provided a method, a computer program product and a device operable to receive a packet at a first network device from a second network device; to decode the received packet using a first decoding scheme defined for decoding a new transmission of a packet, and to also decode the received packet using a second decoding scheme defined for decoding a re-transmission of a packet and, in response to decoding, to determine whether at least a NACK indication that was previously transmitted to the second network device was correctly interpreted by the second network device.

In accordance with another non-limiting embodiment of this invention there is provided a method, a computer program product and a device operable to receive a packet at a first network device from a second network device; to decode the received packet using a first decoding scheme defined for decoding a new transmission of a packet, and to also decode the received packet using a second decoding scheme defined for decoding a re-transmission of a packet and, in response to decoding, to determine whether the received packet is a new transmission of a packet or a re-transmission of a previous packet, without requiring an explicit signaling from the second network device for specifying the type of the packet.

In accordance with still another non-limiting embodiment of this invention there is provided a method, a computer program product and a device operable, in response to transmitting a packet to a first network device, to receive one of an ACK or a NACK indication from the first network device and, in response to receiving an ACK indication, to transmit a first instance of a new packet to the first network device without implicitly signaling that the transmitted packet is a first instance of a new packet.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 is a simplified block diagram a wireless communications system containing devices that are suitable for use in implementing the exemplary embodiments of this invention; and

FIG. 2 is a logic flow diagram that is illustrative of a method, and the operation of a computer program product, in accordance with the exemplary embodiments of this invention.

### DETAILED DESCRIPTION

It is noted at the outset that a description of the operations related to the predefined redundancy versions for HSUPA is described in 3GPP 25.321 v. 7.0.0, section 4.2.3.4. As HSUPA also uses N channel synchronous H-ARQ, the SFN, SAW, soft combining and predefined redundancy version may be inherently derived from HSUPA procedures and techniques. The uplink H-ARQ, in relation to LTE of UTRAN, is discussed in 3GPP 25.814 v.7.0.0, section 9.1.2.5. The disclosures of 3GPP 25.321 v. 7.0.0 and 3GPP 25.814 v.7.0.0 are incorporated by reference herein in their entireties in so far as they may aid in the understanding of the exemplary embodiments of this invention.

To summarize the discussion of uplink H-ARQ in 3GPP 25.814 v.7.0.0, section 9.1.2.5, it is stated that the uplink H-ARQ should be based on Incremental Redundancy, and that Chase Combining is a special case of Incremental Redundancy and is thus implicitly supported as well.

The N-channel Stop-and-Wait protocol is used for uplink H-ARQ.

H-ARQ can be classified as being synchronous or asynchronous. More specifically: Synchronous H-ARQ implies that (re)transmissions for a certain H-ARQ process are restricted to occur at known time instants. No explicit signaling of the H-ARQ process number is required as the process number can be derived from, e.g., the subframe number.

Asynchronous H-ARQ implies that (re)transmission for a certain H-ARQ process may occur at any time. Explicit signaling of the H-ARQ process number is therefore required. In principle, synchronous operation with an arbitrary number of simultaneous active processes at a time instant could be envisioned. In this case, additional signaling may be required. Asynchronous operation already supports an arbitrary number of simultaneous active processes at a time instant. Furthermore, note that, in a synchronous scheme, the transmitter may choose not to utilize all possible retransmission instants, e.g., to support pre-emption. This may require additional signaling.

The various forms of H-ARQ schemes are further classified as adaptive or non-adaptive in terms of transmission attributes, e.g., the Resource unit (RU) allocation, Modulation and transport block size, and duration of the retransmission. Control channel requirements are described for each case.

Adaptive H-ARQ implies the transmitter may change some or all of the transmission attributes used in each retransmission as compared to the initial transmissions (e.g. due to changes in the radio conditions). Hence, the associated control information needs to be transmitted with the retransmission. The changes considered are modulation; Resource Unit allocation and the duration of transmission.

Non-Adaptive H-ARQ implies that changes, if any, in the transmission attributes for the retransmissions, are known to both the transmitter and receiver at the time of the initial transmission. Hence, the associated control information need not be transmitted for the retransmission.

With those definitions, the HS-DSCH in WCDMA uses an adaptive, asynchronous H-ARQ scheme, while E-DCH in WCDMA uses a synchronous, non-adaptive H-ARQ scheme.

The capability of adaptively being able to change the packet format (i.e., adaptive IR) and the transmission timing (i.e., asynchronous IR) yields an adaptive, asynchronous IR-based H-ARQ operation. Such a scheme has the potential of optimally allocating the retransmission resources in a time varying channel. For each H-ARQ retransmission, control information about the packet format needs to be transmitted together with the data sub-packet.

Synchronous H-ARQ transmission entails operating the system on the basis of a predefined sequence of retransmission packet format and timing. The benefits of synchronous H-ARQ operation when compared to asynchronous H-ARQ operation are said to be: a reduction of control signaling overhead. from not signaling H-ARQ channel process number; lower operational complexity if non-adaptive operation is chosen; and the possibility to soft combine control signaling information across retransmissions for enhanced decoding performance if non-adaptive operation is chosen.

For the purpose of conducting a feasibility study, synchronous H-ARQ operation was assumed for the SC-FDMA based E-UTRA uplink, and it is stated that the impact of ACK/NAK signaling errors on synchronous H-ARQ operation needs further study.

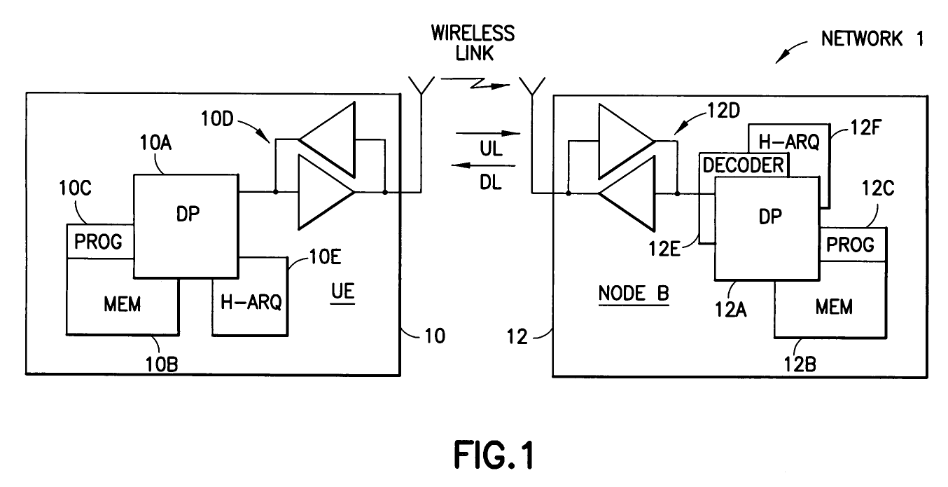

Reference is made to FIG. 1 for illustrating a simplified block diagram of various electronic devices that are suitable for use in practicing the exemplary embodiments of this invention. In FIG. 1 a wireless network 1 is adapted for communication with a UE 10 via a Node B (base station) 12. The network 1 may include a network control function (not shown) that is bidirectionally coupled to the Node B 12. The UE 10 includes a data processor (DP) 10A, a memory (MEM) 10B that stores a program (PROG) 10C, and a suitable radio frequency (RF) transceiver 10D for bidirectional wireless communications with the Node B 12, which also includes a DP 12A, a MEM 12B that stores a PROG 12C, and a suitable RF transceiver 12D. The Node B 12 is typically coupled via a data path to a network control function (not shown). At least one of the PROGs 10C and 12C is assumed to include program instructions that, when executed by the associated DP, enable the electronic device to operate in accordance with the exemplary embodiments of this invention, as will be discussed below in greater detail.

Related more specifically to the exemplary embodiments of this invention, the UE 10 is shown to include a H-ARQ unit or module 10E that is assumed to be responsible for responding to ACK/NACK indications from the Node B 12, and for selectively transmitting a new packet or re-transmitting a previous packet, as required. The Node B 12 is assumed to include a plurality of different types of decoders, indicated generally as the decoders block 12E, as well as a H-ARQ algorithm block 12F that operates in accordance with the exemplary embodiments of this invention as described in further detail below. The modules 10E, 12E and 12F may be embodied in software, firmware and/or hardware, as is appropriate. In general, the exemplary embodiments of this invention may be implemented by computer software executable by at least the DP 12A of the Node B 12 and possibly by other DPs, or by hardware, or by a combination of software and/or firmware and hardware.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B and 12B may be of any type suitable to the local technical environment and may be implemented using any suitable data storage technology, such as semiconductor-based memory devices, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multi-core processor architecture, as non-limiting examples.

As described above, as currently considered for the UTRAN-LTE system the Node B 12 can be expected to have knowledge of only the re-transmission number in order to know the rate matching strategy to be able to perform H-ARQ reception combining. Further, the UL control channel can be expected to carry information related to an indication of new data transmitted from the UE 10. However, the inventor has realized that it is possible to avoid using the new data indication altogether through the use of pre-configuration in conjunction with an estimation (e.g., a blind estimation) of initial data transmissions received from the UE 10.

Consider an exemplary case where the UE 10 has been configured to use five H-ARQ UL SAW channels, and has been instructed to use at most four transmissions for a given packet. When a call is set-up, the Node B 12 resets all counters/timers, and assumes that all received data from a given UE 10 are a first transmission or transmissions from that UE. If a transmission for a SAW channel fails, the Node B sends a NACK that requests the UE 10 to re-transmit (unless the maximum number of re-transmissions has been reached). At this point the UE 10 can receive the NACK as either an ACK or a NACK. That is, due to a possible error in the channel, the NACK indication may possibly be received and interpreted by the UE 10 as an ACK indication. These two situations are described as follows:

### NACK-->NACK: The UE 10 correctly interprets a NACK, and performs a re-transmission using the pre-configured retransmission scheme in a normal fashion.

NACK-->ACK: The UE 10 incorrectly interprets a NACK as an ACK, assumes that the previously transmitted packet was correctly received at the Node B 12, and transmits a new packet (which it should not do). To handle this case, and in accordance with the exemplary embodiments of this invention, the Node B 12 performs at least one and possibly two actions. First, it attempts to decode a newly received packet under the assumption that it is a new transmission (and decodes same using the appropriate redundancy version). If the CRC is correct, the SFN can be extracted from the decoded packet and a NACK message transmitted to higher protocol layers in the Node B 12 (assuming that acknowledged mode is used). If this fails, the Node B attempts to combine the received packet with the packet that was originally erroneously received, and attempts a new decoding, which may be successful.

Further in this regard, and as currently considered, the foregoing activities can occur in the MAC layer. Also, as currently considered it may be assumed that there are two layers of ARQ, the fast L1 (Physical Layer) H-ARQ which is of most interest to the exemplary embodiments of this invention, and another ARQ entity (similar to the RLC-type of ARQ in WCDMA). As such, the upper layer mentioned in the preceding paragraph is the upper layer ARQ, which is only active in acknowledged mode.

It should be appreciated that this procedure may be enhanced such that instead of examining (only) the CRC output, a comparison of soft decoder metrics may be used to express the ‘similarity’ between an originally received packet and a potential new received packet. Such a similarity metric may, for example, be obtained by estimating the data packet of the first reception, followed by a re-coding of same according to the currently used re-transmission strategy. This may be performed for each received packet since it is desirable to detect the case where an ACK is erroneously interpreted as a NACK by the UE 10. If this occurs it would result in an unnecessary re-transmission from the UE 10, instead of in the UE 10 sending a new packet transmission. By operating in this manner one obtains a Node B-based guess or estimate of what to receive in the case that the UE 10 misinterprets either the ACK or the NACK. At the reception of a potential re-transmission, the Node B compares the received symbols to the expected symbols, and if there is at least some degree of similarity the Node B may assume that the reception contains a re-transmission and operates accordingly.

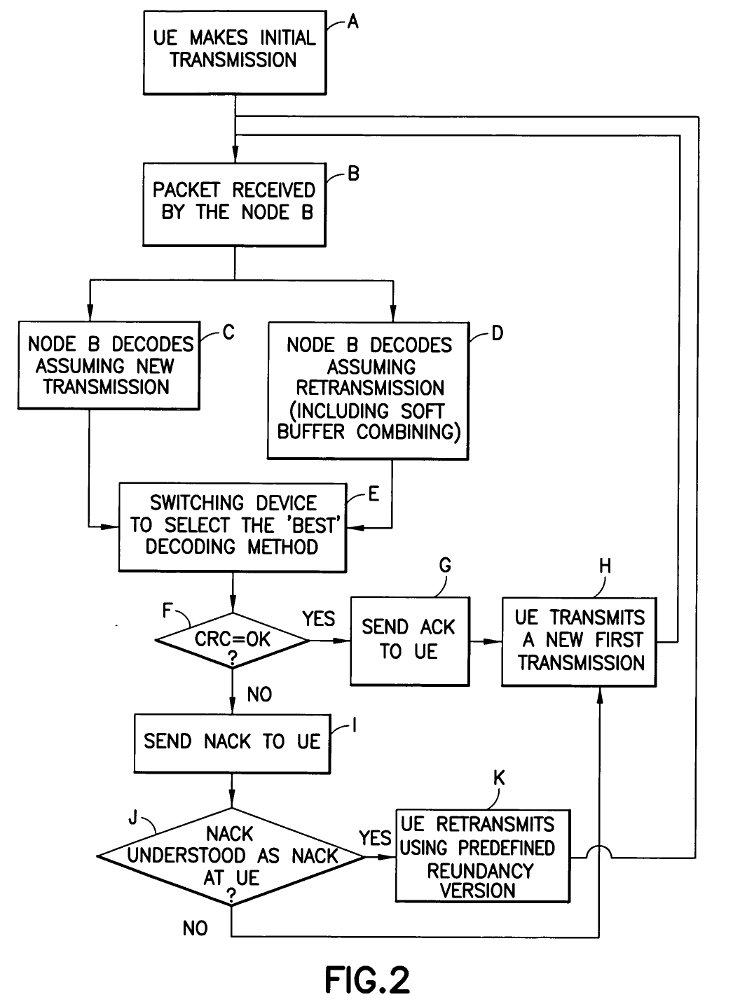

Reference is made to FIG. 2 for illustrating a logic flow diagram that is descriptive of a method, and the operation of a computer program product, further in accordance with the exemplary embodiments of this invention.

At Block A the UE 10 makes an initial transmission of a data packet, and at Block B the packet is received at the Node B. At Blocks C and D the Node B decoder block 12E decodes the received packet assuming that it is a new packet (Block C) and also assuming that it is a re-transmission of a previously transmitted packet (Block D). The operation of Block D implies that the Node B decoder 12E attempts to combine the “soft” output from the applicable decoder with the soft decoder output from the decoding of the previously received packet. At Block E a comparison of the decoding results is made to select the result that exhibits the “best” decoding outcome based on any desirable metric or metrics that are indicative of the quality of the decoding results. Examples of such metrics include, but are not limited to, re-encoding of the received packets assuming different redundancy versions followed by comparing the received data symbols to the reconstructed ones. Alternatively, and further by example, one may perform a set of combinations depending on combining options, and then permit an internal distance metric in a turbo decoder to function as the quality metric.

At Block F the CRC is extracted from the “best” decoded packet to determine if the CRC matches the CRC calculated for the decoded packet. If the CRC check indicates that the packet was correctly decoded control passes to Block G where Node B sends an ACK to the UE 10, and in response at Block H the UE 10 transmits a new packet (new first transmission). Control then returns to Block B. However, if the CRC check at Block F indicates that the packet was not correctly decoded control passes to Block I where the Node B 12 sends a NACK to the UE 10. At this point (indicated by Block J) one of two scenarios can occur, as was discussed above. If the NACK is correctly received and interpreted by the UE 10 then the UE 10 re-transmits the packet using the predefined redundancy version (Block K), and control then passes to Block B. However, if the NACK is not correctly received and interpreted by the UE 10 then the UE 10 instead erroneously transmits the new first transmission (Block H). However, the occurrence of this condition is detected by the Node B by the operation of Blocks C, D, E and F, since when soft combining the newly received and decoded new packet with the previously received packet (Block D), the resulting metrics should be inferior to the result obtained from the operation of Block C (since the received packet is indeed a first new transmission).

Note as well that as a result of the operation of Block G the UE 10 may erroneously receive and interpret the ACK as a NACK. In this case, and instead of control passing to Block H, control would instead pass to Block K to re-transmit the packet. However, this condition will also be detected by the operation of Blocks C, D, E and F since the result of the decoding operation of Block D should be superior to the result of the decoding operation of Block C.

As may be appreciated, an exemplary aspect of this invention is a method, and a computer program product, and a device operable to receive a packet at a first network device from a second network device; to decode the received packet using a first decoding scheme defined for decoding a new transmission of a packet, and also decoding the received packet using a second decoding scheme defined for decoding a re-transmission of a packet and, in response to decoding, determining whether at least a NACK indication that was previously transmitted to the second network device was correctly interpreted by the second network device.

As may be further appreciated, an exemplary aspect of this invention is a method, and a computer program product, and a device operable to receive a packet at a first network device from a second network device; to decode the received packet using a first decoding scheme defined for decoding a new transmission of a packet, and also decoding the received packet using a second decoding scheme defined for decoding a re-transmission of a packet and, in response to decoding, determining whether the received packet is a new transmission of a packet or a re-transmission of a previous packet, without requiring the use of explicit signaling from the second network device for specifying the type of the packet.

Further, one may assume a case that the UE 10 misinterprets the NACK and sends the new packet when it should have re-transmitted the previous packet, and that the Node B 12 correctly receives the new packet. One exemplary action to take in this case would be to use the correctly received packet and inform the ‘upper’ layer(s) that a packet is missing at the lower layer(s). In this manner one may obtain rapid action on missing L1 packets. If a packet is correctly received, it may not be buffered, or it may be buffered for use in testing with a subsequent re-transmission. UE-Node B signaling that may be used, if any, may be handled by, as an example, the outer ARQ functionality (RLC-type ARQ)).

It may be desirable that the use of the exemplary embodiments of this invention be implemented through a specification, such that the necessary information to configure the UE 10 is communicated during call setup, where it is assumed that no associated UL H-ARQ information is required. Correspondingly, the Node B 12 is configured to implement receiver algorithms to enable soft metric calculations to be used for the blind detection of the UL UE 10 transmission(s).

As may be appreciated, one non-limiting advantage that results form the use of the exemplary embodiments of this invention is the associated uplink H-ARQ signaling may be reduced or even eliminated.

Further, it should be appreciated that the exemplary embodiments of this invention are not limited for use with the UTRAN LTE system, but may be employed as well in other types of wireless communications systems such as, but not limited to, the HSUPA system.

Various modifications and adaptations may become apparent to those skilled in the relevant arts in view of the foregoing description, when read in conjunction with the accompanying drawings and the appended claims. As one non-limiting example, while FIG. 2 shows Blocks C and D being performed in parallel, in actuality they may be performed sequentially, in either order. However, all such and similar modifications of the teachings of this invention will still fall within the scope of this invention.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method, comprising:
receiving a packet at a first network device from a second network device;
decoding the received packet using a first decoding scheme defined for decoding a new transmission of a packet, and also decoding the received packet using a second decoding scheme defined for decoding a re-transmission of a packet; and
in response to decoding, determining whether at least a NACK indication that was previously transmitted to the second network device was correctly interpreted by the second network device.

2. The method of claim 1, where a re-transmitted packet is transmitted with a predetermined offset to a corresponding new packet.

3. The method of claim 1, where determining comprises comparing a result of the use of the first decoding scheme with a result of the use of the second decoding scheme for identifying a best decoding scheme for the received packet.

4. The method of claim 1, where the packet is transmitted from the second network device without explicitly signaling the first network device whether the packet is a new transmission.

5. A method, comprising:
receiving a packet at a first network device from a second network device;
decoding the received packet using a first decoding scheme defined for decoding a new transmission of a packet, and also decoding the received packet using a second decoding scheme defined for decoding a re-transmission of a packet; and
in response to decoding, determining whether the received packet is a new transmission of a packet or a re-transmission of a previous packet, without requiring an explicit signaling from the second network device for specifying the type of the packet.

6. The method of claim 5, where a re-transmitted packet is transmitted with a predetermined offset to a corresponding new packet.

7. The method of claim 5, where determining comprises comparing a result of the use of the first decoding scheme with a result of the use of the second decoding scheme for identifying a best decoding scheme for the received packet.

8. The method of claim 5, further comprising, in response to decoding, determining whether an ACK or a NACK indication that was previously transmitted to the second network device was correctly interpreted by the second network device.

9. The method of claim 5, where the second decoding scheme comprises combining the result of the decoding with a result of decoding a previously received packet.

10. The method of claim 5, where the first network device comprises a base station, and where the second network device comprises user equipment.

11. A method, comprising:
in response to transmitting a packet to a first network device from a second network device, receiving one of an ACK or a NACK indication from the first network device; and
in response to receiving an ACK indication, transmitting a first instance of a new packet to the first network device without implicitly signaling that the transmitted packet is a first instance of a new packet.

12. The method of claim 11, where the first network device comprises a base station, and where the second network device comprises user equipment.

13. A computer program product comprising program instructions embodied in a computer readable medium, execution of the program instructions by a data processor resulting operations that comprise:
receiving a packet at a first network device from a second network device;
decoding the received packet using a first decoding scheme defined for decoding a new transmission of a packet, and also decoding the received packet using a second decoding scheme defined for decoding a re-transmission of a packet; and
in response to decoding, determining whether at least a NACK indication that was previously transmitted to the second network device was correctly interpreted by the second network device.

14. The computer program product of claim 13, where a re-transmitted packet is transmitted with a predetermined offset to a corresponding new packet.

15. The computer program product of claim 13, where determining comprises comparing a result of the use of the first decoding scheme with a result of the use of the second decoding scheme for identifying a best decoding scheme for the received packet.

16. The computer program product of claim 13, where the packet is transmitted from the second network device without explicitly signaling the first network device whether the packet is a new transmission.

17. A computer program product comprising program instructions embodied in a computer readable medium, execution of the program instructions by a data processor resulting operations that comprise:
receiving a packet at a first network device from a second network device;
decoding the received packet using a first decoding scheme defined for decoding a new transmission of a packet, and also decoding the received packet using a second decoding scheme defined for decoding a re-transmission of a packet; and
in response to decoding, determining whether the received packet is a new transmission of a packet or a re-transmission of a previous packet, without requiring an explicit signaling from the second network device for specifying the type of the packet.

18. The computer program product of claim 17, where a re-transmitted packet is transmitted with a predetermined offset to a corresponding new packet.

19. The computer program product of claim 17, where determining comprises comparing a result of the use of the first decoding scheme with a result of the use of the second decoding scheme for identifying a best decoding scheme for the received packet.

20. The computer program product of claim 17, further comprising, in response to decoding, determining whether an ACK or a NACK indication that was previously transmitted to the second network device was correctly interpreted by the second network device.

21. The computer program product of claim 17, where the second decoding scheme comprises combining the result of the decoding with a result of decoding a previously received packet.

22. The computer program product of claim 17, where the first network device comprises a base station, and where the second network device comprises user equipment.

23. A computer program product comprising program instructions embodied in a computer readable medium, execution of the program instructions by a data processor resulting operations that comprise:
in response to transmitting a packet to a first network device from a second network device, receiving one of an ACK or a NACK indication from the first network device; and
in response to receiving an ACK indication, transmitting a first instance of a new packet to the first network device without implicitly signaling that the transmitted packet is a first instance of a new packet.

24. The computer program product of claim 23, where the first network device comprises a base station, and where the second network device comprises user equipment.
in response to decoding, determining whether the received packet is a new transmission of a packet or a re-transmission of a previous packet, without requiring an explicit signaling from the second network device for specifying the type of the packet.

25. A device, comprising:
a receiver to receive a packet from a second network device;
a decoder to decode the received packet using a first decoding scheme defined for decoding a new transmission of a packet, and also decoding the received packet using a second decoding scheme defined for decoding a re-transmission of a packet; and
a determination unit, responsive to an output of the decoder, to determine whether at least a NACK indication that was previously transmitted to the second network device was correctly interpreted by the second network device.

26. The device of claim 25, where a re-transmitted packet is transmitted with a predetermined offset to a corresponding new packet.

27. The device of claim 25, where said determination unit comprises a comparator to compare a result of the use of the first decoding scheme with a result of the use of the second decoding scheme for identifying a best decoding scheme for the received packet.

28. The device of claim 25, where the packet is transmitted from the second network device without explicitly signaling the network device whether the packet is a new transmission.

29. A device, comprising:
a receiver to receive a packet from a second network device;
a decoder to decode the received packet using a first decoding scheme defined for decoding a new transmission of a packet, and also decoding the received packet using a second decoding scheme defined for decoding a re-transmission of a packet; and
a determination unit, responsive to an output of the decoder, to determine whether the received packet is a new transmission of a packet or a re-transmission of a previous packet, without requiring an explicit signaling from the second network device for specifying the type of the packet.

30. The device of claim 29, where a re-transmitted packet is transmitted with a predetermined offset to a corresponding new packet.

31. The device of claim 29, where said determination unit comprises a comparator to compare a result of the use of the first decoding scheme with a result of the use of the second decoding scheme for identifying a best decoding scheme for the received packet.

32. The device of claim 29, said determination unit further comprising, in response to decoding, means to determine whether an ACK or a NACK indication that was previously transmitted to the second network device was correctly interpreted by the second network device.

33. The device of claim 29, where the decoder when executing the second decoding scheme comprises means for combining the result of the decoding with a result of decoding a previously received packet.

34. The device of claim 29, where the network device comprises a base station, and where the second network device comprises user equipment.

35. The device of claim 29, embodied at least partially in an integrated circuit.

36. The device of claim 29, where the output of the decoder comprises a CRC.

37. A user equipment, comprising:
a receiver to receive one of an ACK or a NACK indication from a base station in response to transmission of a packet to the base station; and
synchronous automatic repeat request means, responsive to receiving an ACK indication, for sending a first instance of a new packet to the base station without implicitly signaling that the sent packet is a first instance of a new packet.

38. The user equipment of claim 37, where if a NACK indication is received, the synchronous automatic repeat request means sends a re-transmission of a packet sent previously with a predetermined offset relative to the packet sent previously.

39. The user equipment of claim 37, where at least one of the receiver means and the synchronous automatic repeat request means is embodied at least partially in an integrated circuit.

40. The user equipment of claim 37, where at least one of the receiver means and the synchronous automatic repeat request means is embodied at least partially as computer program code that is stored on a computer-readable data storage means.
